(19) United States
(12) Patent Application Publication
(10) Pub. No.: US 2021/0034987 A1
(43) Pub. Date: Feb. 4, 2021

(54) AUXILIARY HANDLING OF METADATA AND ANNOTATIONS FOR A QUESTION ANSWERING SYSTEM

(71) Applicant: International Business Machines Corporation, Armonk, NY (US)

(72) Inventors: OCTAVIAN F. FILOTI, PORTSMOUTH, NH (US); CHRISTOPHER M. NOLAN, ACTON, MA (US)

(21) Appl. No.: 16/529,094

(22) Filed: Aug. 1, 2019

(51) Int. Cl. G06N 5/02; G06N 3/08

(52) U.S. Cl. CPC G06N 5/02; G06N 3/08

(57) ABSTRACT

A method generates a complex response to a question in a question answering system. A core knowledge database stores essential annotations associated with term spans from an original text document. One or more auxiliary knowledge databases store non-essential annotations for the term spans from the original text document. One or more processors establish links among the core knowledge database and the one or more auxiliary knowledge databases by using parallel fields for corresponding term spans, where the parallel fields provide positional term span location information for correlating the essential annotations to the non-essential annotations. The processor(s) receive a question from a question answering system, and then, using the correlated essential annotations and non-essential annotations, fetch term spans that answer the question in a complex response, generate the complex response by using the fetched term spans, and then return the complex response to the question answering system.

### BACKGROUND

The present invention relates to the field of question answering systems. Still more specifically, the present invention relates to the field of auxiliary knowledge bases to store and retrieve non-essential metadata and annotations from a text corpus in the question answering systems.

### SUMMARY

In an embodiment of the present invention, a method generates a complex response to a question in a question answering system. A core knowledge database stores essential annotations associated with term spans from an original text document. One or more auxiliary knowledge databases store non-essential annotations for the term spans from the original text document. One or more processors establish links among the core knowledge database and the one or more auxiliary knowledge databases by using parallel fields for corresponding term spans, where the parallel fields provide positional term span location information for correlating the essential annotations to the non-essential annotations. The processor(s) receive a question from a question answering system, and then, using the correlated essential annotations and non-essential annotations, fetch term spans, from the original text document, that answer the question in a complex response. The processor(s) then generate the complex response created by using the fetched term spans and return the complex response to the question answering system.

In an embodiment of the present invention, processor(s) train an artificial intelligence (AI) system to answer the question by utilizing the parallel fields.

In an embodiment of the present invention, the AI system directs a controller to activate, modify, change a functionality of, and/or otherwise affect a physical device based on the answer that is generated by the AI system.

In one or more embodiments, the method(s) described herein are performed by an execution of a computer program product and/or a computer system.

### BRIEF DESCRIPTION OF THE DRAWINGS

FIG. 1 depicts an exemplary system and network in which the present invention is implemented in various embodiments;

FIG. 2 illustrates a high-level overview of one or more embodiments of the present invention;

FIGS. 3A-3B depicts details of exemplary parallel fields shown in FIG. 2;

FIG. 4 illustrates a high-level overview of one or more alternate embodiments of the present invention;

FIGS. 5A-5B depicts exemplary parallel fields used in FIG. 4;

FIG. 6 illustrates an exemplary neural network as used in one or more embodiments of the present invention;

FIG. 7 is a high-level flow chart of one or more steps performed in accordance with one or more embodiments of the present invention;

FIGS. 8A-8B depicts exemplary hierarchical graphs as used in one or more embodiments of the present invention;

FIG. 9 depicts a cloud computing environment according to an embodiment of the present invention; and

FIG. 10 depicts abstraction model layers of a cloud computer environment according to an embodiment of the present invention.

### DETAILED DESCRIPTION

In one or more embodiments, the present invention is a system, a method, and/or a computer program product at any possible technical detail level of integration. In one or more embodiments, the computer program product includes a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In one or more embodiments, computer readable program instructions for carrying out operations of the present invention comprise assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. In one or more embodiments, the computer readable program instructions execute entirely on the user's computer, partly on the user's computer, as a stand-alone software package, partly on the user's computer and partly on a remote computer or entirely on the remote computer or server. In the latter scenario and in one or more embodiments, the remote computer connected to the user's computer through any type of network, including a local area network (LAN) or a wide area network (WAN), or the connection is made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

In one or more embodiments, these computer readable program instructions are provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In one or more embodiments, these computer readable program instructions are also stored in a computer readable storage medium that, in one or more embodiments, direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In one or more embodiments, the computer readable program instructions are also loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams represents a module, segment, or portion of instructions, which comprises one or more executable instructions for implementing the specified logical function(s). In some alternative implementations, the functions noted in the block occur out of the order noted in the figures. For example, two blocks shown in succession are, in fact, executed substantially concurrently, or the blocks are sometimes executed in the reverse order, depending upon the functionality involved. It will also be noted that, in one or more embodiments of the present invention, each block of the block diagrams and/or flowchart illustration, and combinations of blocks in the block diagrams and/or flowchart illustration, are implemented by special purpose hardware-based systems that perform the specified functions or acts or carry out combinations of special purpose hardware and computer instructions.

Current Information Retrieval (IR) and Question Answering (QA) systems are limited to the amount of metadata and annotations one can align to a term or a span of terms from an original text document, since an excessive quantity of metadata/annotations will saturate a core knowledge base. As such, one or more embodiments of the present invention are directed to a method that allows the utilization of high quantities of metadata and annotations in different knowledge bases (i.e., databases that contain text corpuses, metadata about the text corpuses, and/or annotations about terms in the text corpuses) using parallel fields that logically link the various knowledge bases.

In the prior art, if too much metadata and/or annotations are stored in a core Knowledge Base (KB), the core KB quickly becomes saturated, such that it becomes time consuming to sift through all of the metadata and/or annotations and/or the text itself when looking for an answer to a question. Furthermore, much of the metadata and/or annotations stored in the core KB is rarely used, if at all. Hence, one or more embodiments of the present invention separate the knowledge base into a core and auxiliary components, in which the core KB stores essential metadata and the auxiliary KB(s) store non-essential metadata about text corpuses. Furthermore, these extra auxiliary metadata and annotations can also be used during relevance scoring of the information retrieved.

For purposes of illustrating one or more embodiments of the present invention, assume that a question answering system receives a question “What started the impressionism movement?” A text corpus stored in a core (main) KB might state “Impression, Sunrise is a painting that gave its name to the style of the impressionistic movement.” Metadata that describes information about the entire text corpus might be “impressionism”, “Monet”, or “modern art”, and annotations about specific passages in the text corpus will include descriptions of key terms from the text corpus, including their position distances. These metadata and/or annotations in the core KB are matched to metadata and/or annotations in the auxiliary knowledge bases (auxiliary KBs) in order to identify ancillary metadata/annotations that are rarely used to locate the text corpus “Impression, Sunrise is a painting that gave its name to the style of the impressionistic movement”, and/or to locate text corpuses that bolster or dispute the text corpus in the core KB. Thus, the computer system is improved by allowing key text corpuses to be stored in and retrieved quickly from the core KB, while auxiliary non-essential metadata and/or annotations are retrievable, if so desired, using parallel fields that match terms pairs in the auxiliary KBs with those in the core KB. The primary use of the core KB makes the system run faster, while availability of the auxiliary KBs maintains the expanse of the capabilities of the system.

As described herein, the essential metadata associated with the text corpus and essential annotations associated with a term or span of terms from the text corpus are kept in a core Knowledge Base (KB), which in one or more embodiments is composed of Search Index Collections and/or Relational Databases. In an embodiment of the present invention, also stored in the core KB is the original text corpus. Any other metadata and annotations about/for the original text corpus are stored in auxiliary Knowledge Bases (KBs), while maintaining a link between them and the core KB using parallel fields.

As described herein, parallel fields correlate metadata and/or annotations from the core KB with metadata and/or annotations from auxiliary KBs.

For example, assume in a first embodiment that each metadata and annotation is about a same text corpus (“Impression, Sunrise is a painting that gave its name to the style of the impressionistic movement”). Assume further, for an embodiment of the present invention, that the metadata (about this text corpus) stored in the core KB is different from metadata (about this same text corpus) stored in the auxiliary KBs. Thus, when using metadata to locate this text corpus (“Impression, Sunrise is a painting that gave its name to the style of the impressionistic movement”), the metadata (about that text corpus) found in the core KB is used first. However, if this metadata fails to locate this text corpus (even though the text corpus may be stored within the core KB itself), then other metadata (about this text corpus) found in one or more auxiliary KBs will be searched. In order to know what other metadata is to be searched, the parallel fields will identify which metadata from the core KB is associated with which metadata in the auxiliary KBs.

Thus, at querying time, one or more of these metadata and annotations are used for relevant search retrieval of text from either the core KB and/or any of the auxiliary KB s for the desired terms using their parallel field positional information, thus connecting the same concepts (as identified by different metadata about the entire text corpus) and/or descriptors (for term spans within the text corpus) across different KBs.

A such, the present invention releases the burden of having too much metadata/annotations on a core knowledge base, and makes information retrieval and question answering systems more efficient and more accurate.

As described herein, when correlating annotations between the core KB and the auxiliary KBs, the parallel fields contain positional information of a term or span of terms from an original text document (text corpus), which is relative to a paragraph or sentence (i.e., position offsets), and is included for each term span in all core and auxiliary KBs.

As stated above, the essential metadata and annotations are kept in a core KB, while the rest (non-essential) are in auxiliary KBs. In an embodiment of the present invention, the essential metadata/annotations are those that are used most frequently to locate the text corpus, while non-essential metadata/annotations are those that are used less frequently to locate the text corpus. By utilizing the extra metadata and annotations for a term or span of terms whenever they are needed, they are retrieved from the non-essential metadata/annotations by using the parallel fields positional location information from each auxiliary KB of interest.

In an embodiment of the present invention, assume that syntactic relations annotations are used less frequently than annotations that are based on word recognition. As such, syntactic relations annotations are kept in an auxiliary search index collection, such as a Syntactic-Relations Search Index, and are retrieved using the positional information from the parallel fields, whenever needed. In this way, the whole KB (core and auxiliary) is usable, and not clogged, by keeping the essential metadata and annotations (which are based on word recognition) in a core KB, and the non-essential metadata and annotations (which are based on syntactic relations) are stored in an auxiliary KB.

As described herein, a framework for handling unlimited metadata and annotations using parallel fields is presented, in order to build different knowledge bases and add different metadata for each term. The core KB contains the original text and/or essential metadata and annotations. Every time a KB (either core or auxiliary) becomes congested, it is split into other auxiliary components. Thus, position location information is stored for each text corpus's metadata and annotated text. As such, whenever needed, the system is able to retrieve all metadata from all core and auxiliary KBs for that term.

At ingestion time, the question answering system starts with one (core) KB. Thereafter, when the core KB becomes congested, it is split by keeping the text and essential metadata and annotations in the core KB, and the rest of metadata and annotations in auxiliary KB s. When an auxiliary KB is built from the overflow, positional location information for each term or span of terms in the original text is added to the corresponding parallel fields.

At querying time, the question answering system uses the positional location information from the parallel fields in each KB to connect each term or span of terms to retrieve its metadata and annotations from each desired KB.

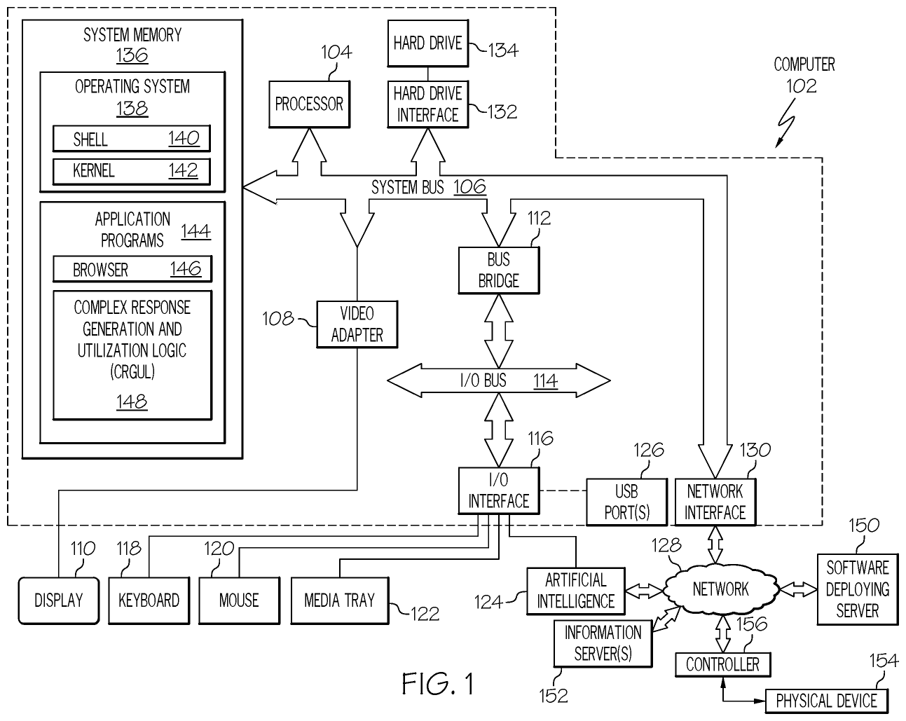

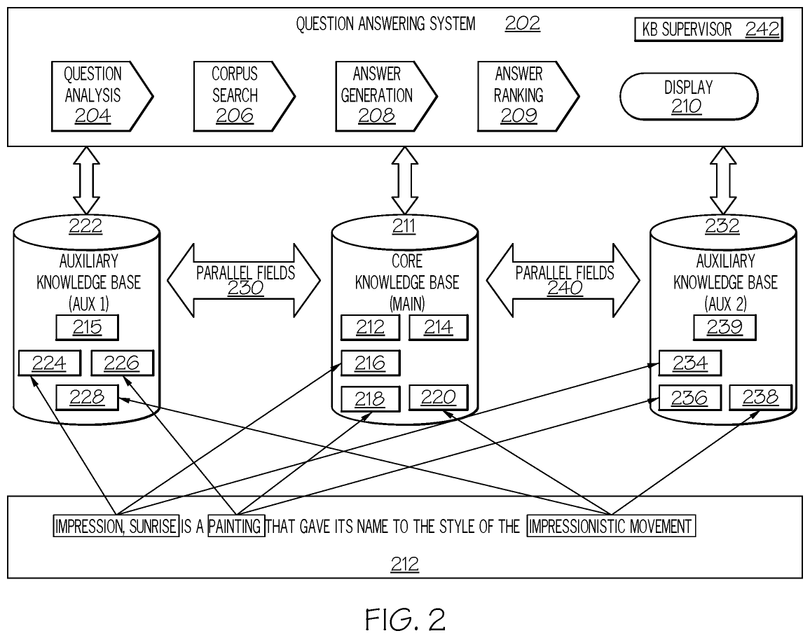

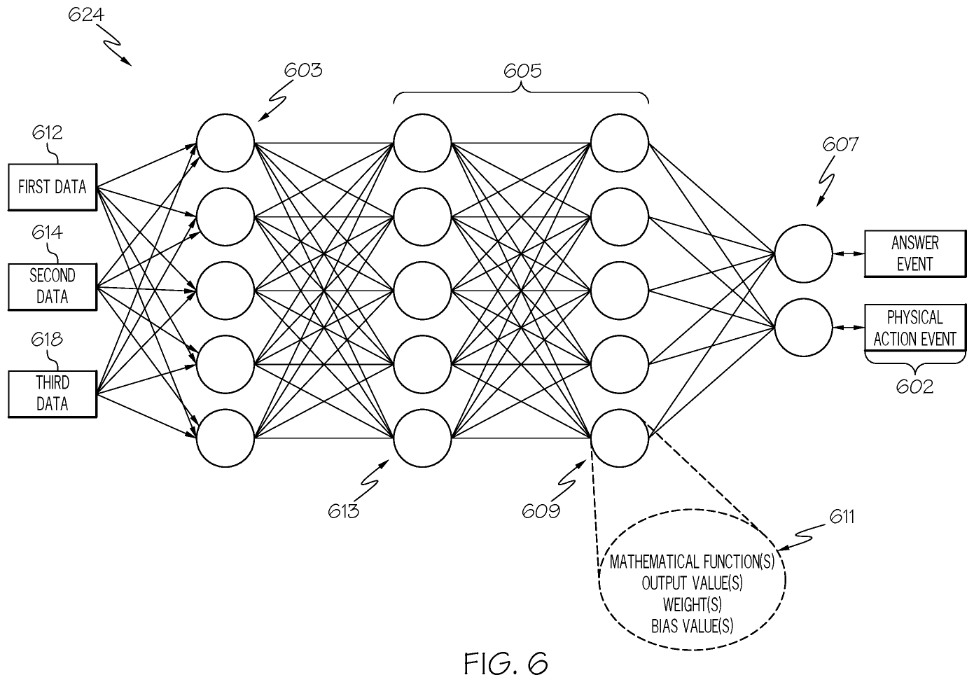

With reference now to the figures, and in particular to FIG. 1, there is depicted a block diagram of an exemplary system and network that can be utilized by and/or in the implementation of the present invention. Note that some or all of the exemplary architecture, including both depicted hardware and software, shown for and within computer 102 can be utilized by artificial intelligence 124 and/or software deploying server 150 and/or information server(s) 152 and/or remote physical device 154 and/or controller 156 shown in FIG. 1, and/or question answering system 202 shown in FIG. 2, and/or one or more of the neurons/nodes shown in Deep Neural Network 624 in FIG. 6.

Exemplary computer 102 includes a processor 104 that is coupled to a system bus 106. Processor 104 can utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which can include storage devices such as CD-ROM drives, multi-media interfaces, etc.), an artificial intelligence 124, and external USB port(s) 126. While the format of the ports connected to I/O interface 116 can be any known to those skilled in the art of computer architecture, in one embodiment some or all of these ports are universal serial bus (USB) ports.

As depicted, computer 102 is able to communicate with a software deploying server 150 and/or the information server(s) 152 and/or the remote device 154 and/or the neural network 124 using a network interface 130 to a network 128. Network interface 130 is a hardware network interface, such as a network interface card (NIC), etc. Network 128 can be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

Application programs 144 in computer 102's system memory (as well as software deploying server 150's system memory) also include a Complex Response Generation and Utilization Logic (CRGUL) 148. CRGUL 148 includes code for implementing the processes described below, including those described in FIGS. 2-8. In one embodiment, computer 102 is able to download CRGUL 148 from software deploying server 150, including in an on-demand basis, wherein the code in CRGUL 148 is not downloaded until needed for execution. Note further that, in one embodiment of the present invention, software deploying server 150 performs all of the functions associated with the present invention (including execution of CRGUL 148), thus freeing computer 102 from having to use its own internal computing resources to execute CRGUL 148.

Also connected to (or alternatively, as part of) computer 102 is an artificial intelligence 124. In exemplary embodiments of the present invention, artificial intelligence 124 is a deep neural network (see FIG. 6), a convolutional neural network, or another type of heuristic artificial intelligence.

Also connected to computer 102 are information server(s) 152, which are used by a question answering system (e.g., computer 102) to retrieve unstructured information, as depicted in the example shown in FIG. 2. That is, information server(s) 152 access the knowledge bases 211, 222, and 232 shown in FIG. 2 in response to questions from the question answering system 202 shown in FIG. 2.

Also connected to computer 102 is a remote physical device 154, which is controlled by a controller 156. One or more examples of physical device 154 are presented below.

Note that the hardware elements depicted in computer 102 are not intended to be exhaustive, but rather are representative to highlight essential components required by the present invention. For instance, computer 102 can include alternate memory storage devices such as magnetic cassettes, digital versatile disks (DVDs), Bernoulli cartridges, and the like. These and other variations are intended to be within the spirit and scope of the present invention.

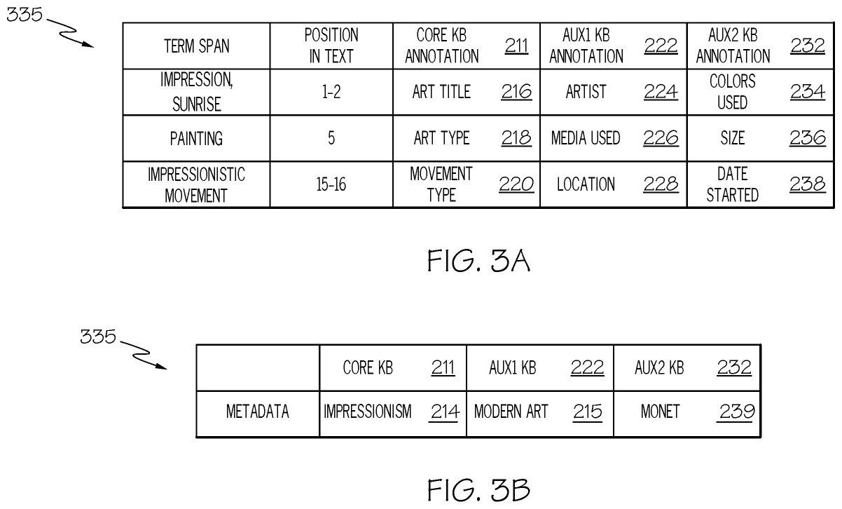

With reference now to FIG. 2 and FIGS. 3A-3B, an overview of details of one or more embodiments of the present invention is presented.

As shown in FIG. 2, a question answering (Q/A) system 202 (analogous to computer 102 shown in FIG. 1) performs five basic steps. Q/A system 202 is a system that mines unstructured information sources to answer a query/question.

First, as shown in block 204, the Q/A system 202 analyzes a received question. For example, assume that a client (e.g., using a webpage that is supported by Q/A system 202) enters the question “What started the impressionism movement?” The Q/A system 202, using a natural language processing (NLP) algorithm will determine that the question is asking for the event or entity (person, group, etc.) that initiated the field of impressionist art.

As shown in block 206, the Q/A system 202 then searches corpuses (i.e., bodies of information), such as the main text corpus 212, which is a paper by Author X, which states that “Impression, Sunrise is a painting that gave its name to the style of the impressionistic movement”. That is, once the context of the question is determined to be a question about the origination of the impressionist movement (using NLP), the Q/A system 202 is able to match these contextual features to answering texts that match the question by using metadata and/or annotations about those answering texts.

As shown in block 208, the Q/A system 202 then generates an answer to the question “What started the impressionism movement?” with the answer “Impression, Sunrise is a painting that gave its name to the style to the impressionistic movement.”

Assume that Q/A system 202 has generated several possible answers, besides “Impression, Sunrise is a painting that gave its name to the style of the impressionistic movement”, to the question “What started the impressionism movement?” As such, and as shown in block 209, the Q/A system 202 ranks these different answers (e.g., according to how closely their contexts match that of the question). For example, an answer such as “Many believe that Monet started it in 1874 in Paris”, or “It might be Monet” are two less definitive answers, and thus are ranked lower than “Impression, Sunrise is a painting that gave its name to the style of the impressionistic movement”. Alternatively, the ranking of the various answers is based on how closely the metadata/annotations in the answers match the metadata/annotations created from the question by the question analysis 204. That is, if the question analysis generated the metadata M1 and annotation A1 and annotation A2, then an answer that includes metadata M1, annotation A1, and annotation A2 is ranked higher than an answer that includes metadata M2, annotation A1, and annotation A3.

Once the Q/A system 202 identifies the highest ranked answer, it is displayed to the user on a display 210 (analogous to display 110 shown in FIG. 1).

Continuing with the example above, which seeks to answer the question “What started the impressionism movement?”, assume that the best answer is found in the main text corpus 212 (“Impression, Sunrise is a painting that gave its name to the style of the impressionistic movement”). However, in order to locate this main text corpus 212, the question answering system 202 will first propose metadata and/or annotations to be used in a search based on the question analysis 204.

As such, question analysis 204 will determine the overall topic (“impressionism”) of the question, and will also develop various fields of annotations (“movement type”, “art title”, “art type”, “artist”, “media used”, “location”, “date”, etc.) of term spans (words or phrases) found in various potential answers. That is, the question analysis 204 will contextually (e.g., using natural language processing) determine that the overall topic is about “impressionism”. Once this overall topic has been determined, then the corpus search 206 will look for text corpuses that have term spans that have been tagged with annotations related to “impressionism” using a context analysis of the question “What started the impressionism movement?” as well as the preferred (essential) metadata “impressionism”. A contextual and/or heuristic analysis by corpus search 206 reveals that relevant annotations include “movement type”, “art title”, “art type”, “artist”, “media used”, “location”, “date”, etc., with “art title”, “art type”, and “movement type” being the preferred (essential) annotations to be used in the search for an answer.

As shown in FIG. 2, assume that the core knowledge base (KB) 211 contains the metadata 214 (“impressionism”) to describe the main text corpus 212, and the annotation 216 (“art title”), annotation 218 (“art type”), and annotation 220 (“movement type”) to describe the respective term spans “Impression, Sunrise”, “painting”, and “impressionistic movement” found in the main text corpus 212. If the question analysis 204 created these metadata/annotations based on the user's question (“What started the impressionism movement?”), then the main text corpus 212 is retrieved by the answer generation 208, and the search for an answer is completed.

However, assume now that the question analysis 204 actually generated metadata and/or annotations (from the user's question) that are different from what are found in the core KB 211. That is, one or more of the metadata and/or annotations generated by the question analysis 204 do not match what is found in the core KB 211. For example, assume that the question analysis 204 generated the metadata “modern art” as the overall descriptor of the question and the corresponding answer, and is looking for annotations “artist”, “media used”, and/or “location” for corresponding term spans “Impression, Sunrise”, “painting”, and “impressionistic movement” in candidate texts in order to locate the correct answer.

As shown in FIG. 2, the metadata 215 (“modern art”) is shown in auxiliary knowledge base (KB) 222, along with annotation 224 (“artist”), annotation 226 (“media used”), and annotation 228 (“location”) to describe the respective term spans “Impression, Sunrise”, “painting”, and “impressionistic movement” found in the main text corpus 212.

As shown in FIG. 2, the metadata 239 (“Monet”) is shown in auxiliary knowledge base (KB) 232, along with annotation 234 (“colors used”), annotation 236 (“size of the painting”), and annotation 238 (“date started”) to describe the respective term spans “Impression, Sunrise”, “painting”, and “impressionistic movement” found in the main text corpus 212.

Initially, all of the metadata (214, 215, 239) and all of the annotations (216, 218, 220, 224, 226, 228, 234, 236, 238) are initially located within core KB 211. However, if all of the metadata and annotations were to be left within core KB 211, then core KB 211 would be so saturated that it would be difficult, if not practically impossible, to utilized any of these metadata and annotations. Thus, whenever core KB 211 becomes oversaturated (i.e., contains more than a predefined quantity of metadata and/or annotations that have been predetermined to take more than a predefined amount of resources, time, etc. to utilize), then only essential metadata/annotations (214, 216, 218, 220) remain within the core KB 211, while non-essential metadata/annotations (from 215, 224, 226, 228, 239, 234, 236, 238) are split out and migrated to an auxiliary KB (e.g., auxiliary KB 222). Once that auxiliary KB 222 becomes saturated, then its most used metadata/annotations (215, 224, 226, 228) are kept within auxiliary KB 222, while non-essential metadata/annotations (239, 234, 236, 238) are sent to another auxiliary KB 232.

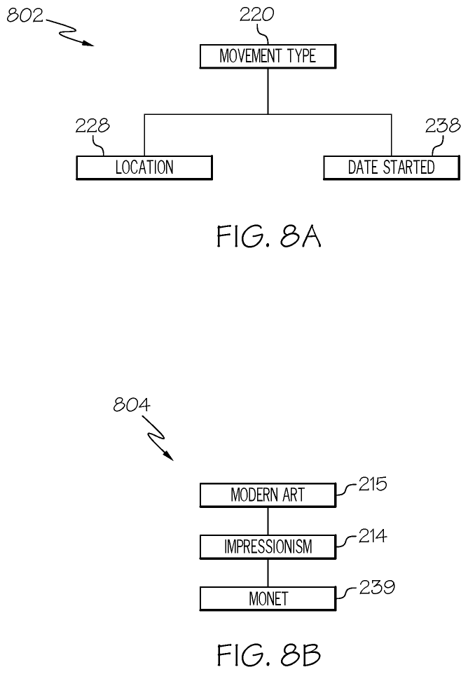

The term “essential”, when used to describe either metadata or annotations, is defined as a descriptor of those metadata/annotations that are most commonly used when searching for an answer to a particular type of question, such as the question “What started the impressionism movement?” (or its grammatical/contextual equivalent). That is, essential metadata/annotations have a history of being used in the past more often than other metadata/annotations when answering a particular type of question (“What started the impressionism movement?”). Thus, essential metadata/annotations are those that have been used in the past by a question answering system, tested, and determined to be the most commonly (frequently) used metadata/annotations for answering a particular type of question. Such essential metadata/annotations can also have the characteristics of being small enough to be efficiently handled within a core KB (assuming that their presence would not cause an overflow of data in the core KB), or are high in a hierarchical graph, as described below in FIGS. 8A-8B.

Essential metadata/annotations are preferably stored in the core knowledge base (KB) described herein. However, if the core KB becomes saturated (having so much data that either no new data can be stored therein, or else the quantity of data makes retrieval and usage excessively slow), then essential metadata/annotations are migrated to auxiliary KBs.

The term “non-essential”, when used to describe either metadata or annotations, is defined as a descriptor of those metadata/annotations that have been used less often in the past than “essential” metadata/annotations for locating an answer to a particular type of question, such as the question “What started the impressionism movement?” (or its grammatical/contextual equivalent). That is, non-essential metadata/annotations are defined as those that have historically been less commonly (frequently) used than essential metadata/annotations when searching for an answer to a particular type of question. Such non-essential metadata/annotations can also have the characteristic of being lower in a hierarchical graph than essential metadata/annotations.

The core KB and auxiliary KBs described herein are preferably constructed before ingestion time (when the metadata/annotations are actually used by the question answering system), since adding metadata/annotations and building such KBs is very time consuming, and thus is preferably done rarely.

The question answering system 202 (e.g., using its knowledge base supervisor 242, which is logic within the question answering system 202 for keeping track of which KB has certain metadata/annotations) will keep track of how often certain metadata/annotations are successfully used to locate the main text corpus 212 when answering a question similar to “What started the impressionism movement?” Thus, if metadata 215 (“modern art”) is used more often than metadata 214 (“impressionism”), and/or annotation 224 (“artist”) is used more often than annotation 216 (“art title”), then metadata 215 (“modern art”) and annotation 224 (“artist”) are kept in core KB 211, and metadata 214 (“impressionism”) and annotation 216 (“art title”) are migrated out to auxiliary KB 222.

Assume now, for purposes of illustration of one or more embodiments of the present invention, that rather than the question analysis 204 generating metadata 214 (“impressionism”), annotation 216 (“art title”), annotation 218 (“art type”), and annotation 220 (“movement type”), it generated the metadata 215 (“modern art”); and annotation 224 (“artist”), annotation 226 (“media used”), and annotation 228 (“location”) for the respective term spans “Impression, Sunrise”, “painting”, and “impressionistic movement”. As such, the question answering system 202 will query the auxiliary KB 222 using these metadata/annotations, in order to locate the main text corpus 212 to answer the question “What started the impressionism movement?”

Alternatively, assume that rather than the question analysis 204 generating metadata 214 (“impressionism”), annotation 216 (“art title”), annotation 218 (“art type”), and annotation 220 (“movement type”), it generated the metadata 239 (“Monet”); and annotation 234 (“colors used”), annotation 236 (“size”), and annotation 238 (“date started”) for the respective term spans “Impression, Sunrise”, “painting”, and “impressionistic movement”. As such, the question answering system 202 will query the auxiliary KB 232 using these metadata/annotations, in order to locate the main text corpus 212 to answer the question “What started the impressionism movement?”

In an embodiment of the present invention, and as shown in FIG. 2, the question answering system 202 directly accesses all of the KBs (including core KB 211, auxiliary KB 222, and auxiliary KB 232) looking for text corpuses that have the metadata/annotations generated by the question answering system 202. In another embodiment, the question answering system 202 must first query the core KB 211, which will then request metadata/annotation information from auxiliary KB 222 and/or auxiliary KB 232 if necessary. In either embodiment, parallel fields 230 and/or parallel fields 240 are needed.

Exemplary parallel fields 335, which are essentially a composite of parallel fields 230 and parallel fields 240 shown in FIG. 2, are depicted in FIGS. 3A-3B. While parallel fields 335 represent a combination of parallel fields 230 and parallel fields 240, in another embodiment parallel fields 335 are broken up into just metadata fields and just annotation fields. In yet another embodiment of the present invention, parallel fields 335 are broken up into parallel fields 230 and parallel field 240, such that only corresponding metadata/annotations for the two associated KBs are represented. That is, parallel fields 230 would associate metadata 215 with metadata 212, and would also associate annotation 224 with annotation 216, annotation 226 with annotation 218, and annotation 228 with annotation 220.

Assume again that the question answering system 202 can directly access all of the KBs (including core KB 211, auxiliary KB 222, and auxiliary KB 232), as shown in FIG. 2. Assume further, however, that the question answering system 202 is looking for an answer that uses the metadata 214 (“impressionism”), but uses annotation 224 (“artist”), annotation 226 (“media used”), and annotation 228 (“location”) for the respective term spans “Impression, Sunrise”, “painting”, and “impressionistic movement”.

As shown in parallel fields 335, core KB 211 has metadata 214 (“impressionism”). However, auxiliary KB 222 has annotation 224 (“artist”), annotation 226 (“media used”), and annotation 228 (“location). This requires core KB 211 and auxiliary KB 222 to work together, such that core KB 211 looks for a text corpus that uses the metadata 214 (“impressionism”), but auxiliary KB 222 provides the annotation 224 (“artist”), annotation 226 (“media used”), and annotation 228 (“location”), which is used by the core KB 211 to search for the answer text corpus. Note that even though annotation 216 (“art title”), annotation 218 (“art type”), and annotation 220 (“movement type”) have been the most successful in locating the answer in the past, these are not the annotations that are being requested by the question analysis 204.

Therefore, by referencing the parallel fields 335 shown in FIGS. 3A-3B, core KB 211 recognizes that annotation 224 (“artist”) is equivalent to annotation 216 (“art title”); annotation 226 (“media used”) is equivalent to annotation 218 (“art type”); and annotation 228 (“location”) is equivalent to annotation 220 (“movement type”) when describing the respective term spans “Impression, Sunrise”, “painting”, and “impressionistic movement” from the main text corpus 212 shown in FIG. 2. As such, core KB 211 locates the main text corpus 212 that has the metadata 214 (“impressionism”) along with the equivalence of annotation 216 (“art title”), annotation 218 (“art type”), and annotation 220 (“movement type”), as the answer to the question “What started the impressionism movement?”

In another embodiment, however, the question answering system 202 directly accesses only core KB 211. As such, if core KB 211 does not have all of the metadata/annotations found in the query submitted by the question answering system 202, it will reference the parallel fields 335 in order to identify the auxiliary knowledge base(s) needed to identify the main text corpus 212 that answers the question “What started the impressionistic movement”.

In an embodiment of the present invention, as presented in FIG. 2, the question answering system 202 is looking for a text corpus other than the main text corpus 212 that answers the question “What started the impressionist movement?” That is, assume that the question analysis 204 and/or corpus search 206 developed, from the question “What started the impressionistic movement?”, metadata 215 (“modern art”), and annotation 224 (“artist”), annotation 226 (“media used”), and annotation 228 (“location”) to describe term spans found in the candidate corpuses.

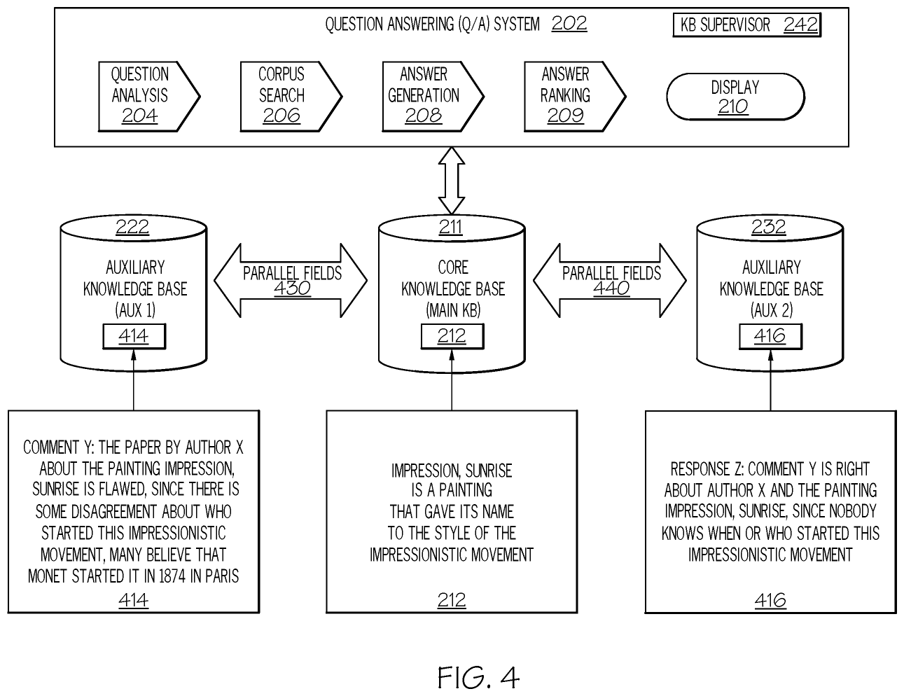

FIG. 4 depicts three candidate text corpuses: main text corpus 212 (introduced and discussed above); auxiliary text corpus 414; and auxiliary text corpus 416. As shown in FIG. 4, auxiliary text corpus 414 is stored in auxiliary KB 222 (in order to be close to the metadata/annotations shown within auxiliary KB 222 in FIG. 2), and auxiliary text corpus 416 is stored in auxiliary KB 232 (in order to be close to the metadata/annotations shown within auxiliary KB 232 in FIG. 2). Alternatively, auxiliary text corpus 414 and auxiliary text corpus 416 are stored in any location, including but not limited to core KB 211.

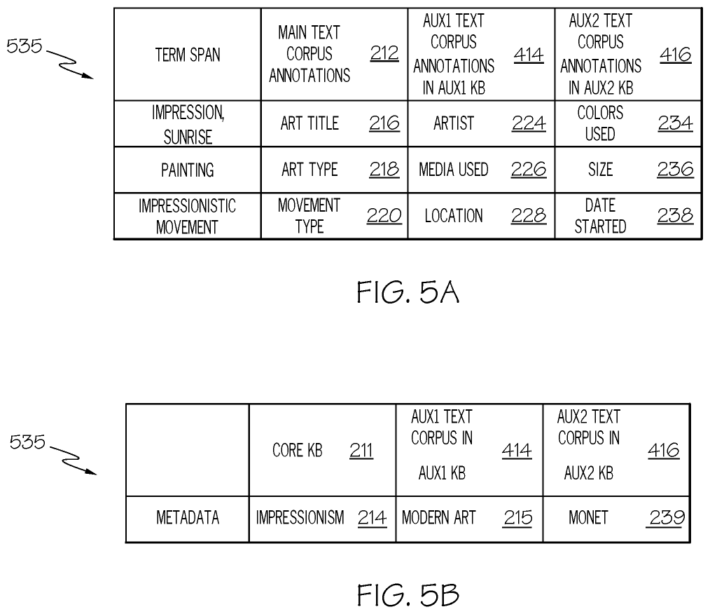

Continue to assume, for illustrative purposes, that question answering system 202 has developed from the question “What started the impressionistic movement?” the metadata 215 (“modern art”), and annotation 224 (“artist”), annotation 226 (“media used”), and annotation 228 (“location”) to describe term spans found in the candidate corpuses. When this information is sent to the core KB 211, it is unable to use it, since it has other metadata/annotations that it uses to look for a text corpus that answers the question. However, core KB 212 has access to parallel fields 430 and parallel fields 440, shown as a composite in FIGS. 5A-5B as parallel fields 535, which shows that auxiliary knowledge base 222 has an auxiliary text corpus 414, which auxiliary knowledge base 222 has tagged with the metadata 215 (“modern art”), and annotation 224 (“artist”), annotation 226 (“media used”), and annotation 228 (“location”). Since this is exactly what the question answering system 202 is looking for, then auxiliary text corpus 414 is returned to the question answering system 202.

Similarly, assume that question answering system 202 has developed, from the question “What started the impressionistic movement?”, metadata 239 (“Monet”), and annotation 234 (“colors used”), annotation 236 (“size”), and annotation 238 (“date started”) to describe term spans found in the candidate corpuses. When this information is sent to the core KB 211, it again is unable to use it, since it has other metadata/annotations that it uses to look for a text corpus that answers the question. However, core KB 212 has access to parallel fields 430 and parallel fields 440, shown as a composite in FIGS. 5A-5B as parallel fields 535, which shows that auxiliary knowledge base (AUX2 KB) 232 has an auxiliary text corpus 416, which auxiliary knowledge base (AUX1 KB) 222 has tagged with the metadata 239 (“Monet”), and annotation 234 (“colors used”), annotation 236 (“size”), and annotation 238 (“date started”). Since this is exactly what the question answering system 202 is looking for, then auxiliary text corpus 416 is returned to the question answering system 202.

In one or more embodiments, the present invention uses an electronic neural network, which is an example of the artificial intelligence 124 shown in FIG. 1, to identify correlations between answers, determine if a physical action is to be performed, etc. In various embodiments of the present invention, the artificial intelligence 124 shown in FIG. 1 is a Deep Neural Network (DNN), a Convolutional Neural Network (CNN), and/or another type of machine learning system. In a preferred embodiment, a Deep Neural Network is used to evaluate text/numeric data in a user utterance, while a CNN is used to evaluate an image provided by a user in a comment, query, etc. that is the user's utterance.

A neural network, as the name implies, is roughly modeled after a biological neural network (e.g., a human brain). A biological neural network is made up of a series of interconnected neurons, which affect one another. For example, a first neuron can be electrically connected by a synapse to a second neuron through the release of neurotransmitters (from the first neuron) which are received by the second neuron. These neurotransmitters can cause the second neuron to become excited or inhibited. A pattern of excited/inhibited interconnected neurons eventually lead to a biological result, including thoughts, muscle movement, memory retrieval, etc. While this description of a biological neural network is highly simplified, the high-level overview is that one or more biological neurons affect the operation of one or more other bio-electrically connected biological neurons.

An electronic neural network similarly is made up of electronic neurons. However, unlike biological neurons, electronic neurons are never technically “inhibitory”, but are only “excitatory” to varying degrees.

In an electronic neural network, neurons are arranged in layers, known as an input layer, hidden layer(s), and an output layer. The input layer includes neurons/nodes that take input data, and send it to a series of hidden layers of neurons, in which all neurons from one layer in the hidden layers are interconnected with all neurons in a next layer in the hidden layers. The final layer in the hidden layers then outputs a computational result to the output layer, which is often a single node for holding vector information.

With reference now to FIG. 6, a Deep Neural Network (DNN) 624 used to evaluate textual data in one or more embodiments of the present invention is presented. For example, assume, for illustrative purposes, that first data 612 is data from main text corpus 212 shown in FIG. 4, second data 614 is data from auxiliary text corpus 414 shown in FIG. 4, and third data 618 is from auxiliary text corpus 416 shown in FIG. 4. As such, first data 612, second data 614, and third data 618 are entered into the input layer 603 of the deep neural network 624.

As shown in FIG. 6, the electronic neurons in DNN 624 are arranged in layers, known as the input layer 603, hidden layers 605, and an output layer 607. The input layer 603 includes neurons/nodes that take input data, and send it to a series of hidden layers of neurons (e.g., hidden layers 605), in which neurons from one layer in the hidden layers are interconnected with all neurons in a next layer in the hidden layers 605. The final layer in the hidden layers 605 then outputs a computational result to the output layer 607, which is often a single node for holding vector information. In an embodiment of the present invention, each neuron in the output layer 607 is associated with a particular response label from event labels 602, as shown in FIG. 6.

As just mentioned, each node in the depicted DNN 624 represents an electronic neuron, such as the depicted neuron 609. As shown in block 611, each neuron (including neuron 609) includes at least four features: a mathematical function, an output value, a weight, and a bias value.

The mathematical function is a mathematic formula for processing data from one or more upstream neurons. For example, assume that one or more of the neurons depicted in the middle hidden layers 605 send data values to neuron 609. Neuron 609 then processes these data values by executing the mathematical function shown in block 611, in order to create one or more output values, which are then sent to another neuron, such as another neuron within the hidden layers 605 or a neuron in the output layer 607. Each neuron also has a weight that is specific for that neuron and/or for other connected neurons. Furthermore, the output value(s) are added to bias value(s), which increase or decrease the output value, allowing the DNN 624 to be further “fine tuned”.

For example, assume that neuron 613 is sending the results of its analysis of a piece of data to neuron 609. Neuron 609 has a first weight that defines how important data coming specifically from neuron 613 is. If the data is important, then data coming from neuron 613 is weighted heavily, and/or increased by the bias value, thus causing the mathematical function (s) within neuron 609 to generate a higher output, which will have a heavier impact on neurons in the output layer 607. Similarly, if neuron 613 has been determined to be significant to the operations of neuron 609, then the weight in neuron 613 will be increased, such that neuron 609 receives a higher value for the output of the mathematical function in the neuron 613. Alternatively, the output of neuron 609 can be minimized by decreasing the weight and/or bias used to affect the output of neuron 609. These weights/biases are adjustable for one, some, or all of the neurons in the DNN 624, such that a reliable output will result from output layer 607. Such adjustments are alternatively performed manually or automatically.

When manually adjusted, the weights and/or biases are adjusted by the user in a repeated manner until the output from output layer 607 matches expectations. For example, assume that DNN 624 is being trained to answer the question “Who started the impressionism movement?” As such, when input layer 603 receives the inputs of first data 612, second data 614, and third data 618 (as described above), then DNN 624 (if properly trained by manually adjusting the mathematical function(s), output value(s), weight(s), and biases in one or more of the electronic neurons within DNN 624) outputs a correct output vector to the output layer 607. More specifically, it provides an answer event (“Monet started the impressionism movement in 1874.”) and a physical action event.

The physical action event is an event at a physical device. In the example just described above for Monet and the impressionist movement, such a physical device could be an alarm system that is monitoring a Monet painting. Since the system now knows that Monet is the originator of the impressionist movement, and thus his works are important, then the alarm system is adjusted by a controller (e.g., computer 102 shown in FIG. 1) to be more sensitive. That is, the alarm system could originally be set to go off if patrons get within 12 inches of any art in an exhibit. However, for a Monet painting, the same alarm system is set to go off if patrons get within three feet of the Monet painting.

When automatically adjusted, the weights (and/or mathematical functions) are adjusted using “back propagation”, in which weight values of the neurons are adjusted by using a “gradient descent” method that determines which direction each weight value should be adjusted to.

A CNN is similar to a NN in that both utilize interconnected electronic neurons. However, a CNN is different from a NN in that 1) a CNN has neural layers whose sizes are based on filter sizes, stride values, padding values, etc., and 2) a CNN utilizes a convolution scheme to analyze image data. A CNN gets its “convolutional” name based on a convolution (i.e., a mathematical operation on two functions to obtain a result) of filtering and pooling pixel data (a mathematical operation on two functions) in order to generate a predicted output (obtain a result).

While the data and examples described above are for artists and their works, in other embodiments of the present invention such data is for industrial purposes.

For example, assume that the first data 612 is from a main corpus about a pump in a refinery, the second data 614 is from an auxiliary corpus about that pump, and the third data 616 contains parallel fields information that links the first data 612 and the second data 614 (e.g., via their annotations). Assume further, for purposes of illustration, that the first data 612 and the second data 614 address the question “What should the operating pressure of Pump Z be?”. As such, if the answer event is “The operating pressure of Pump Z should be 15 pounds per square inch-psi”, but Pump Z is detected by its controller (e.g., controller 156 shown in FIG. 1, which receives pressure signals from a pressure sensor on Pump Z—not shown) as operating at 20 psi, then the controls will reduce the speed of Pump Z until it is only generating 15 psi of pressure.

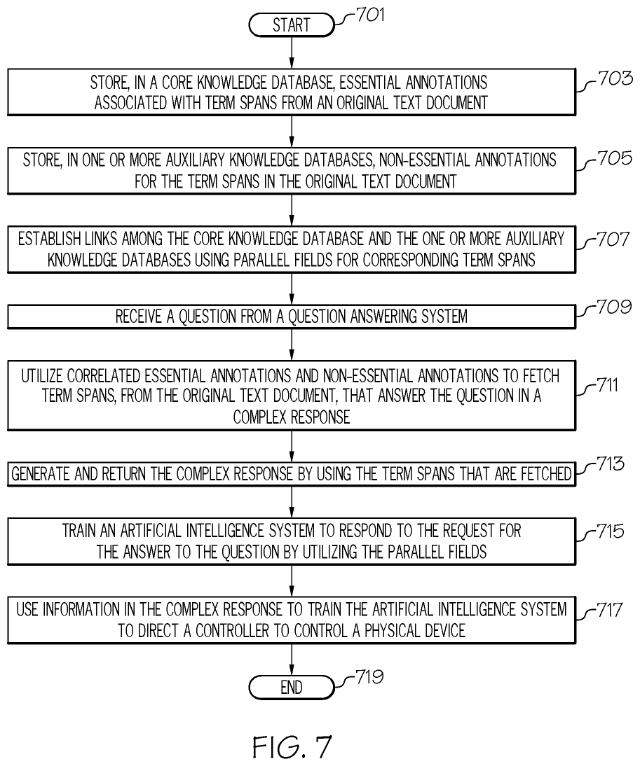

With reference now to FIG. 7, a high-level flow chart of one or more embodiments of the present invention is presented.

After initiator block 701, one or more processors (e.g., processor 104 in computer 102) store, in a core knowledge database (e.g., core KB 211 shown in FIG. 2) essential annotations associated with term spans (e.g., multiple words such as “Impression, Sunrise” or “impressionistic movement” or a single word such as “painting”) in original text documents (e.g., main text corpus 212), as described in block 703. As described above, essential metadata and annotations are those that are used most frequently, due to their success in the retrieval of answers to certain types of questions.

As described in block 705, non-essential annotations (e.g., annotations 224, 226, 228, 234, 236, 238 shown in FIG. 2) for the term spans from the original text document are stored in one or more auxiliary knowledge databases (e.g., auxiliary KB 222 and auxiliary KB 232 shown in FIG. 2). As described above, these “non-essential annotations” are those that are used less frequently than then “essential annotations” when searching for an answer to a particular type of question.

As described above in FIG. 2, in an embodiment of the present invention, essential metadata (e.g., metadata 214—“impressionism), which describes all of the of the (subject matter) of the original text document, is also stored in the core knowledge database. Non-essential metadata (e.g., metadata 222—“modern art”, metadata 239—“Monet”), which also has been assigned to (determined to) describe all of the original text document, is stored in the one or more auxiliary knowledge databases. As with essential annotations and non-essential annotations, essential metadata is that metadata which has been used more frequently than non-essential metadata in the past to successfully locate and retrieve answers to particular types of questions.

While usage frequency is used to identify/define essential and non-essential metadata/annotations in one or more embodiments of the present invention, hierarchical positioning is used to identify/define essential and non-essential metadata/annotations in one or more embodiments of the present invention. For example, consider the annotation hierarchical graph 802 and the metadata hierarchical graph 804 shown in FIGS. 8A-8B.

With regard to annotation hierarchical graph 802, the annotation 220 (“movement type”) is higher in the hierarchy of annotations than annotation 228 (“location”) and annotation 238 (“date started”), since annotation 228 and annotation 238 provide additional sub-categorical information about the main annotation/category “movement type”.

As such, annotation 220 is deemed to be an “essential” annotation for use when searching for an answer to a question about impressionism, and annotation 228 and annotation 238 are deemed to be “non-essential” annotations in such a search.

Similarly, and with regard to metadata hierarchical graph 804, the metadata 239 (“Monet”) is a sub-topic of metadata 214 (“impressionism”), which is a sub-topic of metadata 215 (“modern art”).

As such, metadata 215 (“modern art”) is deemed to be an “essential” metadata for use when searching for an answer to a question about impressionism, and metadata 214 (“impressionism”) and metadata 239 (“Monet”) are deemed to be “non-essential” annotations in such a search, even though metadata 214 was previously used more often than metadata 215 or metadata 239 when successfully searching for an answer to a question about impressionism.

That is, the hierarchical relationships among annotations and/or the hierarchical relationships among metadata is used along with and/or instead of historical frequency in determining which annotation/metadata is essential and which annotation/metadata is non-essential.

While annotation hierarchical graph 802 is depicted as showing a hierarchy of annotations, and metadata hierarchical graph 804 is depicted as showing a hierarchy of metadata, it is understood that the annotation hierarchical relationships of annotations shown in annotation hierarchical graph 802 (i.e., a branched hierarchy) is also applicable when describing a hierarchy of metadata. Similarly, the linear hierarchy shown in metadata hierarchical graph 804 for metadata can also be used to depict a linear hierarchy for annotations.

Returning to FIG. 7, as shown in block 707, one or more processors establish links among the core knowledge database and the one or more auxiliary knowledge databases by using parallel fields for corresponding term spans, as described in FIG. 2. As described above in FIGS. 3A-3B, the parallel fields provide positional term span location information for correlating the essential annotations to the non-essential annotation.

As described in block 709, one or more processors receive a question from a question answering system (e.g., question answering system 202 shown in FIG. 2).

As described in block 711, the one or more processors use the correlated essential annotations and non-essential annotations to locate term spans from the original text document that answers the question in a complex response. That is, the identified span terms are located and returned.

As described in block 713, the one or more processors then generate the complex response by using the term spans that are fetched and return it to the question answering system. In an embodiment of the present invention, the complex response is simply the text corpus (e.g., main text corpus 212) that is associated with the metadata/annotations requested by the question answering system. Alternatively, a composite answer is generated using text from the main text corpus 212 and/or the auxiliary text corpus 414 and/or the auxiliary text corpus 416 shown in FIG. 4, by using a combination of terms identified by the metadata/annotations supplied by the question answering system. For example, a combination of these corpuses could result in an answer such as “The impressionism movement began with the 1874 premier of the Monet painting Impression, Sunrise in Paris.”

Returning to FIG. 7, and as described in block 715, in an embodiment of the present invention the question answering system trains an artificial intelligence system to respond to the request for the answer to the question by utilizing data from various text corpuses that have been identified by the parallel fields.

That is, and as shown in FIG. 6, data from various text corpuses shown in FIG. 4 are used as inputs the artificial intelligence system (e.g., a neural network such as DNN 624), which results in a final answer (e.g., “The impressionism movement began with the 1874 premier of the Monet painting Impression, Sunrise in Paris.”) or a physical action event (e.g., controlling a particular unit of equipment).

As described in block 717, information in the complex response to train an artificial intelligence system to direct a controller to control nominal operations of a physical device and/or to direct a controller to change a functionality of a physical device.

That is, as described above, the artificial intelligence 124 shown in FIG. 1 uses the complex answer to normally control a device (e.g., directs controller 156 keeps a certain pump (physical device 154) operating at a predefined speed).

Alternatively, the artificial intelligence 124 uses the complex answer to change the functionality of the physical device 154. For example, assume that the physical device is a pressure vessel that stores gas (such as natural gas) at a high pressure, in order to maintain that gas in a liquid state. However, a question from the question answering system could be “How much compressed natural gas does the refinery need today?”, to which the invention described herein returns a complex answer “No compressed natural gas is needed in the refinery today. But the system will need extra diesel feedstock today.” As such, the controller 156 will stop compressing and storing natural gas in that pressure tank, and instead will store diesel feedstock in its non-compressed state. Thus, the functionality of the physical device 154 changes from functioning as a high pressure tank to functioning as a low pressure tank.

The flow chart ends at terminator block 719.

In one or more embodiments, the present invention is implemented using cloud computing. Nonetheless, it is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model includes at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but still is able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. In one or more embodiments, it is managed by the organization or a third party and/or exists on-premises or off-premises.

Community cloud: the cloud infrastructure is shared by several organizations and supports a specific community that has shared concerns (e.g., mission, security requirements, policy, and compliance considerations). In one or more embodiments, it is managed by the organizations or a third party and/or exists on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

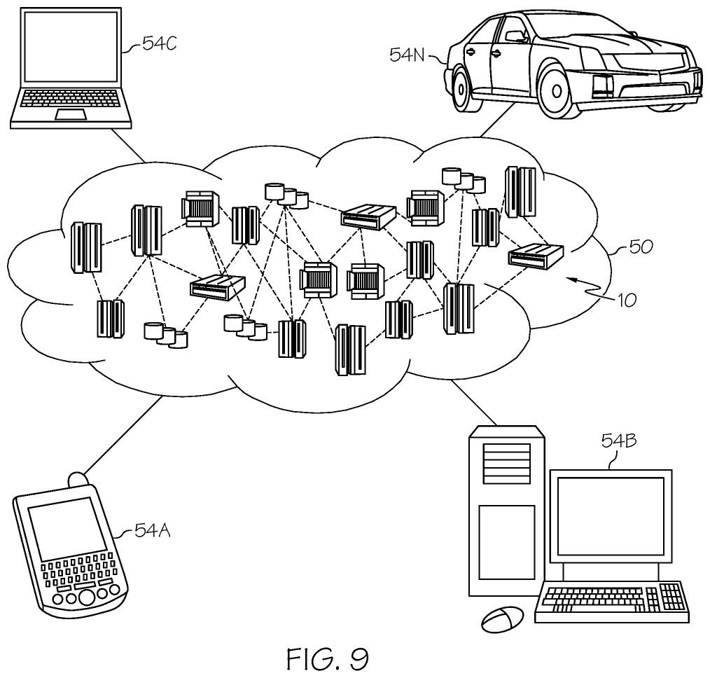

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N communicate with one another. Furthermore, nodes 10 communicate with one another. In one embodiment, these nodes are grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 9 are intended to be illustrative only and that computing nodes 10 and cloud computing environment 50 can communicate with any type of computerized device over any type of network and/or network addressable connection (e.g., using a web browser).

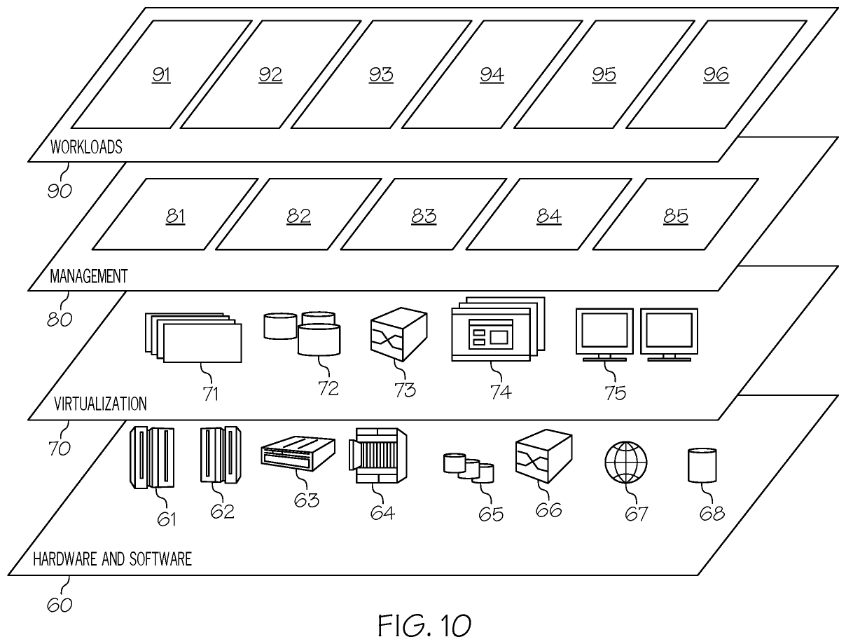

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities that are provided in one or more embodiments: virtual servers 71; virtual storage 72; virtual networks 73, including virtual private networks; virtual applications and operating systems 74; and virtual clients 75.

In one example, management layer 80 provides the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment are utilized in one or more embodiments. Examples of workloads and functions which are provided from this layer include: mapping and navigation 91; software development and lifecycle management 92; virtual classroom education delivery 93; data analytics processing 94; transaction processing 95; and complex response generation and utilization processing 96, which performs one or more of the features of the present invention described herein.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

In one or more embodiments of the present invention, any methods described in the present disclosure are implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, in one or more embodiments of the present invention any software-implemented method described herein is emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method comprising:
storing, in a core knowledge database, essential annotations associated with term spans from an original text document;
storing, in one or more auxiliary knowledge databases, non-essential annotations for the term spans from the original text document;
establishing, by one or more processors, links among the core knowledge database and the one or more auxiliary knowledge databases by using parallel fields for corresponding term spans, wherein the parallel fields provide positional term span location information for correlating the essential annotations to the non-essential annotations;
receiving, by the one or more processors, a question from a question answering system;
using, by the one or more processors, the correlated essential annotations and non-essential annotations to fetch term spans, from the original text document, that answer the question in a complex response;
generating, by the one or more processors, the complex response by using the term spans that are fetched; and
returning, by the one or more processors, the complex response to the question answering system.

2. The method of claim 1, wherein the essential annotations have a history of more frequent use than the non-essential annotations in identifying term spans used to answer the question.

3. The method of claim 1, wherein the essential annotations are higher in a hierarchy of annotations than the non-essential annotations, wherein the hierarchy of annotations describes a syntactic relationship between annotations.

4. The method of claim 1, wherein one or more term spans from the term spans is a single word.

5. The method of claim 1, further comprising:
training, by the question answering system, an artificial intelligence system to respond to the question by utilizing data from various text corpuses that have been identified by the parallel fields.

6. The method of claim 5, wherein the artificial intelligence system is a neural network.

7. The method of claim 1, further comprising:
using information in the complex response to train an artificial intelligence system to direct a controller to control nominal operations of a physical device.

8. The method of claim 1, further comprising:
using information in the complex response to train an artificial intelligence system to direct a controller to change a functionality of a physical device.

9. The method of claim 1, further comprising:
storing, in the core knowledge database, essential metadata that describes all of the original text document; and
storing, in the one or more auxiliary knowledge databases, non-essential metadata that describes all of the original text document.

10. A computer program product comprising a computer readable storage medium having program code embodied therewith, wherein the computer readable storage medium is not a transitory signal per se, and wherein the program code is readable and executable by a processor to perform a method comprising:
storing, in a core knowledge database, essential annotations associated with term spans from an original text document;
storing, in one or more auxiliary knowledge databases, non-essential annotations for the term spans from the original text document;
establishing links among the core knowledge database and the one or more auxiliary knowledge databases by using parallel fields for corresponding term spans, wherein the parallel fields provide positional term span location information for correlating the essential annotations to the non-essential annotations;
receiving a question from a question answering system;
using the correlated essential annotations and non-essential annotations to fetch term spans, from the original text document, that answer the question in a complex response;
generating the complex response by using the term spans that are fetched; and
returning the complex response to the question answering system.

11. The computer program product of claim 10, wherein the method further comprises:
training an artificial intelligence system to respond to the question by utilizing data from various text corpuses that have been identified by the parallel fields.

12. The computer program product of claim 10, wherein the method further comprises:
using information in the complex response to train an artificial intelligence system to direct a controller to control nominal operations of a physical device.

13. The computer program product of claim 10, wherein the program code is provided as a service in a cloud environment.

14. A computer system comprising one or more processors, one or more computer readable memories, and one or more computer readable non-transitory storage mediums, and program instructions stored on at least one of the one or more computer readable non-transitory storage mediums for execution by at least one of the one or more processors via at least one of the one or more computer readable memories, the stored program instructions executed to perform a method comprising:
storing, in a core knowledge database, essential annotations associated with term spans from an original text document;
storing, in one or more auxiliary knowledge databases, non-essential annotations for the term spans from the original text document;
establishing links among the core knowledge database and the one or more auxiliary knowledge databases by using parallel fields for corresponding term spans, wherein the parallel fields provide positional term span location information for correlating the essential annotations to the non-essential annotations;
receiving a question from a question answering system;
using the correlated essential annotations and non-essential annotations to fetch term spans, from the original text document, that answer the question in a complex response;
generating the complex response by using the term spans that are fetched; and
returning the complex response to the question answering system.

15. The computer system of claim 14, wherein the essential annotations have a history of more frequent use than the non-essential annotations in identifying term spans used to answer the question.

16. The computer system of claim 14, wherein one or more term spans from the term spans is a single word.

17. The computer system of claim 14, wherein the method further comprises:
training an artificial intelligence system to respond to the question by utilizing data from various text corpuses that have been identified by the parallel fields.

18. The computer system of claim 14, wherein the method further comprises:
using information in the complex response to train an artificial intelligence system to direct a controller to control nominal operations of a physical device.

19. The computer system of claim 14, wherein the method further comprises:
using information in the complex response to train an artificial intelligence system to direct a controller to change a functionality of a physical device.

20. The computer system of claim 14, wherein the stored program instructions are provided as a service in a cloud environment.
